(19) United States
(12) Patent Application Publication
(10) Pub. No.: US 2025/0171583 A1
(43) Pub. Date: May 29, 2025

(54) REINFORCING RESIN COMPOSITION AND MOUNTED STRUCTURE

(71) Applicant: Panasonic Intellectual Property Management Co., Ltd., Osaka (JP)

(72) Inventor: SHOHEI SANADA, Hyogo (JP)

(21) Appl. No.: 18/944,038

(22) Filed: Nov. 12, 2024

(30) Foreign Application Priority Data
Nov. 24, 2023 (JP) 2023-199387

(51) Int. Cl. C08G 59/56; C08G 59/22; C08G 59/24; C08G 59/38; C08G 59/50; C08G 59/68

(52) U.S. Cl. CPC C08G 59/56; C08G 59/245; C08G 59/5006; C08G 59/5026; C08G 59/5033; C08G 59/681; C08G 59/686; C08G 59/226; C08G 59/38

(57) ABSTRACT

A reinforcing resin composition includes: an epoxy compound; an aromatic amine compound having an active hydrogen equivalent of 50 g/eq. or more and 320 g/eq. or less; and an alicyclic amine compound having an active hydrogen equivalent of 30 g/eq. or more and 50 g/eq. or less.

### BACKGROUND

### 1. Technical Field

The present disclosure relates to a reinforcing resin composition and a mounted structure, and more particularly to a reinforcing resin composition containing an epoxy compound, and a mounted structure including a reinforcing part including a cured product of the reinforcing resin composition.

### 2. Description of the Related Art

Unexamined Japanese Patent Publication No. 2020-025973 discloses a flux composition containing 20 wt % or more and 50 wt % or less of an epoxy compound, 15 wt % or more and 45 wt % or less of diallyl bisphenol A, and 1 wt % or more and 30 wt % or less of an organic acid, a solder junction using the flux composition, and a solder joining method using the flux composition.

### SUMMARY

In an embodiment of the present disclosure, a reinforcing resin composition includes: an epoxy compound; an aromatic amine compound having an active hydrogen equivalent of 50 g/eq. or more and 320 g/eq. or less; and an alicyclic amine compound having an active hydrogen equivalent of 30 g/eq. or more and 50 g/eq. or less.

In an embodiment of the present disclosure, a mounted structure includes: a base material including a first conductor; a mounted component including a second conductor; a solder bump electrically connecting the first conductor to the second conductor, the solder bump being disposed between the first conductor and the second conductor; and a reinforcing part including a cured product of the reinforcing resin composition. The reinforcing part covers at least one of a joint between the first conductor and the solder bump or a joint between the second conductor and the solder bump.

In a reinforcing resin composition according to an embodiment of the present disclosure, the cured product has adhesion to a metal, and deterioration of adhesion due to moisture absorption can be suppressed.

### BRIEF DESCRIPTION OF THE DRAWINGS

FIG. 1 is a schematic cross-sectional view illustrating a mounted structure according to the exemplary embodiment of the present disclosure;

FIG. 2 is a schematic cross-sectional view illustrating a mounted structure according to the first modification of the present disclosure; and

FIG. 3 is a schematic cross-sectional view illustrating a mounted structure according to the second modification of the present disclosure.

### DETAILED DESCRIPTIONS OF EMBODIMENTS

Hereinafter, problems of the prior art will be briefly described.

When an electronic component and a substrate or the like are mounted by soldering, the junction of each of the electronic component and the substrate may be reinforced by a reinforcing part including a cured product of a resin composition such as a flux composition (see Unexamined Japanese Patent Publication No. 2020-025973). In order to realize reinforcement by a reinforcing part, the reinforcing part should be sufficiently adhered to a metal electrode, a metal bump, and the like. However, when the reinforcing part absorbs moisture in the air, adhesion between the reinforcing part and the metal may be deteriorated.

The present disclosure provides a reinforcing resin composition in which the cured product has adhesion to a metal, and deterioration of adhesion due to moisture absorption can be suppressed, and a mounted structure including a reinforcing part including a cured product of the reinforcing resin composition.

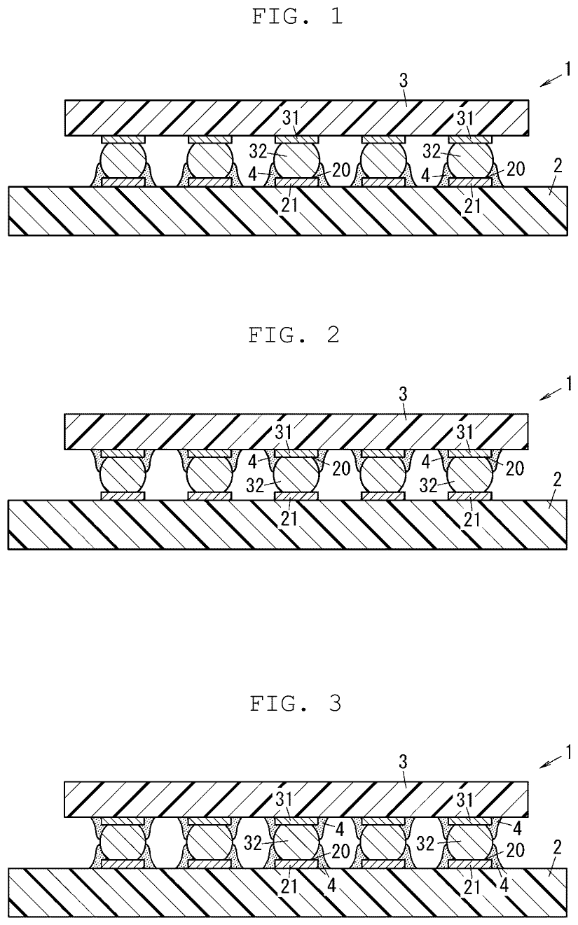

The exemplary embodiments and modifications will be described with reference to FIG. 1 to FIG. 3. However, the exemplary embodiments and the modifications are merely a part of various exemplary embodiments of the present disclosure. In addition, the exemplary embodiments and the modifications can be variously changed depending on design and the like as long as an object of the present disclosure can be achieved. The configuration of the embodiment and the configuration of the modification can be appropriately combined, and the configurations of the modifications can be appropriately combined. Hereinafter, the drawings for reference are schematic drawings, and dimensional ratios of the components in the drawings do not necessarily reflect actual dimensional ratios. Hereinafter, mechanisms relating to action and effect may be described, but all the mechanisms are analogized, and the present disclosure is not limited to the description of the mechanisms.

### 1. OUTLINE

In the exemplary embodiment, the reinforcing resin composition (hereinafter, also referred to as composition (X)) includes: an epoxy compound (A); an aromatic amine compound (B1) having an active hydrogen equivalent of 50 g/eq. or more and 320 g/eq. or less; and an alicyclic amine compound (B2) having an active hydrogen equivalent of 30 g/eq. or more and 50 g/eq. or less.

According to the exemplary embodiment, when the composition (X) is cured in a state of contacting with a metal, the cured product of the composition (X) can have good adhesion to the metal. In addition, the hygroscopicity of the cured product is reduced, and thus adhesion of the cured product to the metal is hardly deteriorated by moisture absorption.

The composition (X) can be used to prepare a reinforcing part in a mounted structure.

In the exemplary embodiment, the mounted structure includes a base material, a mounted component, a solder bump, and a reinforcing part. The base material includes a first conductor. The mounted component includes a second conductor. The solder bump is interposed between the first conductor and the second conductor, and electrically connects the first conductor to the second conductor. The reinforcing part includes a cured product of the composition (X), and covers at least one of a joint between the first conductor and the solder bump or a joint between the second conductor and the solder bump.

According to the exemplary embodiment, the reinforcing part can have good adhesion to the solder bump and the like, and deterioration of adhesion can be suppressed when the reinforcing part absorbs moisture. For example, when the reinforcing part is heated in a reflow furnace or the like in a state where the reinforcing part has absorbed moisture in the air, adhesion between the surface of the solder bump or the like and the reinforcing part is deteriorated, and the reinforcing part may be peeled off in some cases. In this case, the reinforcing action by the reinforcing part may be insufficiently obtained. However, in the exemplary embodiment, since the reinforcing part is less likely to absorb moisture, adhesion between the reinforcing part and the solder bump or the like can be maintained well.

### 2. COMPOSITION

The composition (X) will be described in more detail.

The epoxy compound (A) is a compound having an epoxy group. The epoxy compound (A) may contain a monomer, and may contain an oligomer. The epoxy compound (A) can impart thermosetting properties to the composition (X). The epoxy compound (A) preferably contains a compound having two or more epoxy groups in one molecule.

The epoxy compound (A) is preferably liquid at normal temperature. In that case, in the composition (X), the epoxy compound (A) and other components can be mixed well. Note that meaning of liquid at normal temperature is having fluidity in a state where the ambient temperature is 5° C. or more and 28° C. or less (particularly around 20° C.) under atmospheric pressure. The epoxy compound (A) may contain only a component that is liquid at normal temperature, or may contain a component that is liquid at normal temperature and a component that is not liquid at normal temperature. Optionally, the epoxy compound (A) is not liquid at normal temperature, and the epoxy compound (A) is compatible with a reactive diluent, a solvent, or the like in the composition (X), and thereby the composition (X) is liquid.

A proportion of the epoxy compound (A) in the solid content of the composition (X) is preferably 48 mass % or more and 85 mass % or less. In this case, the composition (X) can have good fluidity, and the composition (X) is easily applied to the joint between the conductor and the solder bump. The proportion is preferably 49 mass % or more. The proportion is preferably 80 mass % or less. Note that the solid content is the component other than the component that volatilizes in the process of producing a cured product (solvent or the like) among the components in the composition (X). In other words, the solid content is the component that can constitute a cured product.

The epoxy compound (A) preferably includes an epoxy compound (A1) including at least one selected from a group consisting of a naphthalene epoxy resin, a biphenyl aralkyl epoxy resin, a trisphenol methane epoxy resin, a biphenyl epoxy resin, and a dicyclopentadiene epoxy resin. In this case, the glass transition temperature of the cured product can be further increased. This is presumably because the epoxy compound (A1) has a highly rigid structure.

Specifically, it is presumed that each of a naphthalene epoxy resin, a biphenyl aralkyl epoxy resin, a trisphenol methane epoxy resin, a biphenyl epoxy resin, and a dicyclopentadiene epoxy resin, having two or more cyclic structures in one molecule, is restricted in molecular chain movement, and thereby the cured product thereof has a high glass transition point.

The naphthalene epoxy resin is an epoxy compound having one or more naphthalene skeletons in one molecule. The naphthalene epoxy resin has a naphthalene skeleton, which has rigidity and hydrophobicity. Thereby the cured product of the composition (X) can have an improved glass transition temperature.

The biphenyl aralkyl epoxy resin is an epoxy compound having one or more aralkyl skeletons having a biphenyl group in one molecule. The biphenyl aralkyl epoxy resin has a rigid biphenyl group in the aralkyl skeleton. Thereby a glass transition temperature of the cured product of the composition (X) can be increased.

The trisphenol methane epoxy resin is an epoxy compound having three phenylmethane skeleton epoxy groups in one molecule. The trisphenol methane epoxy resin has a high functional group (epoxy group) density. Thereby a glass transition temperature of the cured product of the composition (X) can be increased.

The dicyclopentadiene epoxy resin is an epoxy compound having one or more dicyclopentadiene skeletons in one molecule. The dicyclopentadiene epoxy resin has a rigid dicyclopentadiene skeleton. Thereby a glass transition temperature of the cured product of the composition (X) can be increased.

The epoxy group equivalent of the epoxy compound (A1) is preferably 100 or more and 500 or less.

The naphthalene epoxy resin includes, for example, at least one selected from a group consisting of a compound represented by a following formula (11), a compound represented by a following formula (12), a compound represented by a following formula (13), a compound represented by a following formula (14), a compound represented by a following formula (15), and a compound represented by a following formula (16). Examples of the compound represented by the formula (11) include HP-4032D (semi-solid), which is manufactured by DIC Corporation. Examples of the compound represented by the formula (12) include HP-4700 (softening point: 85° C. to 95° C.) and HP-4710 (softening point: 85° C. to 105° C.), each of which is manufactured by DIC Corporation. Examples of the compound represented by the formula (13) include EXA-4750 (softening point: 80° C.), which is manufactured by DIC Corporation. Examples of the compound represented by the formula (14) include HP-4770 (softening point: 67° C. to 77° C.), which is manufactured by DIC Corporation. Examples of a mixture of the compound represented by the formula (15) and the compound represented by the formula (16) include HP-6000 (softening point: 65° C. to 85° C.) and HP-6000L (softening point: 59° C.), each of which is manufactured by DIC Corporation.

The trisphenol methane epoxy resin includes, for example, at least one selected from a group consisting of a compound represented by a following formula (17), a compound represented by a following formula (18), and a compound represented by a following formula (19). Examples of the compound represented by the formula (17) include HP-7241 (softening point: 66° C.), which is manufactured by DIC Corporation. Examples of the compound represented by the formula (18) include HP-7250 (semi-solid), which is manufactured by DIC Corporation. Examples of the compound represented by the formula (19) include EPPN-501H (softening point: 51° C. to 57° C.), EPPN-501HY (softening point: 57° C. to 63° C.), and EPPN-502H (softening point: 60° C. to 72° C.), each of which is manufactured by Nippon Kayaku Co., Ltd.

The biphenyl aralkyl epoxy resin includes, for example, a compound represented by a formula (20). Examples of the compound represented by the formula (20) include NC-3000 (softening point: 53° C. to 63° C.), NC-3000L (softening point: 45° C. to 60° C.), NC-3000-H (softening point: 65° C. to 75° C.), and NC-3100 (softening point: 90° C. to 103° C.), each of which is manufactured by Nippon Kayaku Co., Ltd.

The biphenyl epoxy resin includes, for example, a compound represented by a formula (21). Examples of the compound represented by the formula (21) include YH4000 (softening point: 105° C.) and YX4000H (softening point: 105° C.), each of which is manufactured by Mitsubishi Chemical Corporation.

The dicyclopentadiene epoxy resin includes, for example, a compound represented by a formula (22). Examples of the compound represented by the formula (22) include HP-7200 (softening point: 56° C. to 66° C.), HP-7200L (softening point: 50° C. to 60° C.), HP-7200H (softening point: 78° C. to 88° C.), HP-7200HH (softening point: 88° C. to 98° C.), and HP-7200HHH (softening point: 100° C. to 110° C.), each of which is manufactured by DIC Corporation, and XD-1000 (softening point: 68° C. to 78° C.), which is manufactured by Nippon Kayaku Co., Ltd.

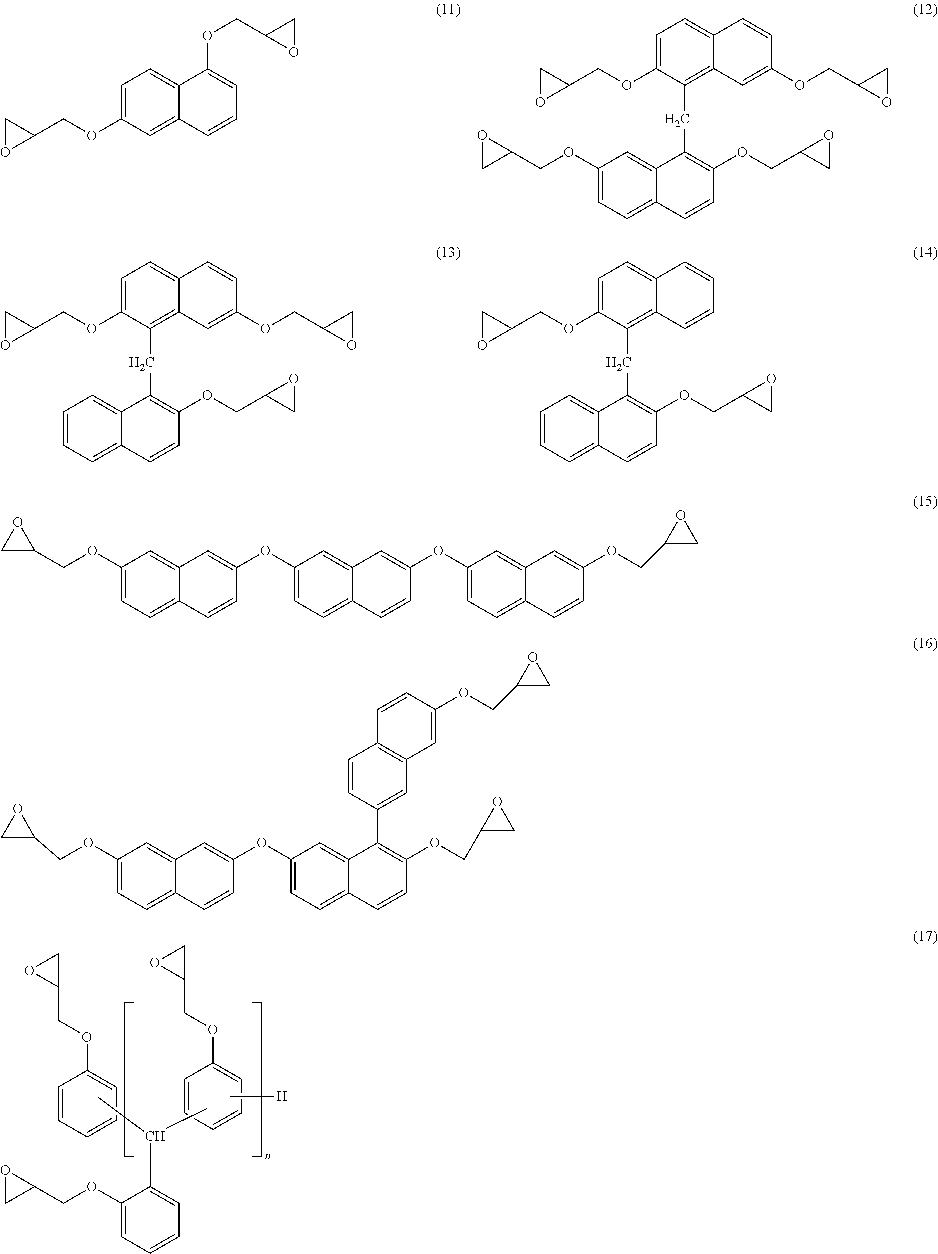

In the formula (17), “n” represents an integer in a range of 1 to 10.

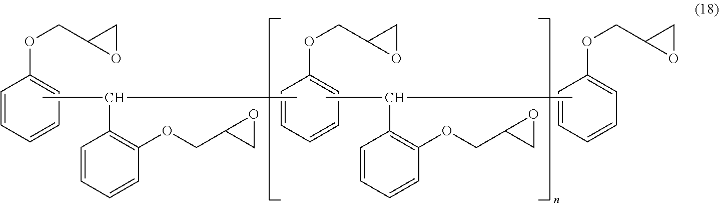

In the formula (18), “n” represents an integer in a range of 1 to 10.

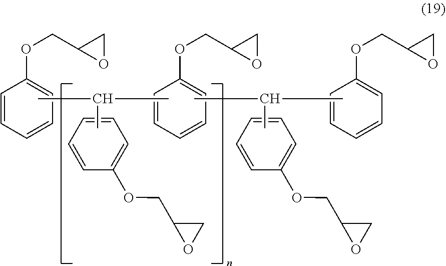

In the formula (19), “n” represents an integer in a range of 1 to 10.

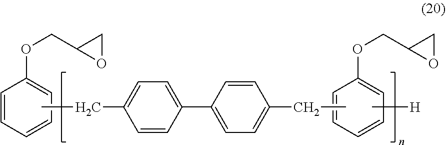

In the formula (20), “n” represents an integer in a range of 1 to 10.

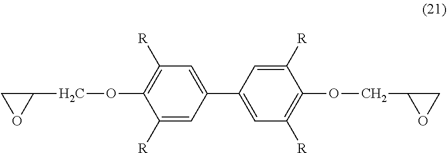

In the formula (21), R represents a methyl group.

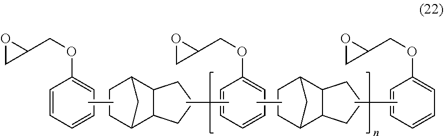

In the formula (22), “n” represents an integer in a range of 1 to 10.

A proportion of the epoxy compound (A1) in the solid content of the composition (X) is preferably 16 mass % or more and 35 mass % or less. When the proportion is 16 mass % or more, the glass transition temperature of the cured product can be increased. The proportion is more preferably 18 mass % or more. When the proportion is 35 mass % or less, there is an advantage that the fluidity of the composition (X) is easily secured. The proportion is more preferably 32 mass % or less.

The epoxy compound (A) may include a compound other than the epoxy compound (A1) (hereinafter, referred to as epoxy compound (A2)).

When the epoxy compound (A) includes the epoxy compound (A1), the epoxy compound (A1) is likely to be semi-solid or solid. Thus, preferably, the epoxy compound (A) includes the epoxy compound (A2) in addition to the epoxy compound (A1), and thereby the epoxy compound (A) is liquid as a whole. In this case, the composition (X) can have better fluidity.

When the epoxy compound (A) includes the epoxy compound (A1) and the epoxy compound (A2), the proportion of the epoxy compound (A1) is the epoxy compound (A) is preferably 30 mass % or more and 40 mass % or less.

The epoxy compound (A2) contains, for example, a compound that is liquid and has lower rigidity than the epoxy compound (A1). The epoxy compound (A2) may include, for example, at least one selected from a group consisting of a glycidyl ether epoxy resin, a glycidyl amine epoxy resin, a glycidyl ester epoxy resin, an olefin oxidized (alicyclic) epoxy compound, bisphenol epoxy resins such as a bisphenol A epoxy resin and a bisphenol F epoxy resin, hydrogenated bisphenol epoxy resins such as a hydrogenated bisphenol A epoxy resin and a hydrogenated bisphenol F epoxy resin, an alicyclic epoxy compound, a phenol novolac epoxy resin, a cresol novolac epoxy resin, an aliphatic epoxy compound, and a triglycidyl isocyanurate.

The epoxy compound (A2) more preferably includes at least one selected from a group consisting of a bisphenol A epoxy resin, a bisphenol F epoxy resin, a hydrogenated bisphenol A epoxy resin, and a hydrogenated bisphenol F epoxy resin. In this case, the viscosity of the composition (X) can be reduced, and the physical properties of the cured product of the composition (X) can be improved.

In the exemplary embodiment, the composition (X) includes a curing agent (B), and the curing agent (B) includes an aromatic amine compound (B1) having an active hydrogen equivalent of 50 g/eq. or more and 320 g/eq. or less; and an alicyclic amine compound (B2) having an active hydrogen equivalent of 30 g/eq. or more and 50 g/eq. or less. Hence, in the exemplary embodiment, as described above, the cured product of the composition (X) can have good adhesion to a metal, and the cured product is less likely to absorb moisture, so that a decrease in adhesion with time due to moisture absorption can be suppressed. The reason has not been sufficiently clarified, but is presumed as follows.

The aromatic amine compound (B1) can contribute to adhesion between the cured product and a metal. The aromatic amine compound (B1) tends to increase the hygroscopicity of the cured product, but when the alicyclic amine compound (B2) is used in combination, the moisture absorption of the cured product is hardly excessively increased.

When the active hydrogen equivalent of the aromatic amine compound (B1) is 50 g/eq. or more, moisture absorption of the cured product caused by an active hydrogen in the cured product can be suppressed. When the active hydrogen equivalent of the aromatic amine compound (B1) is 320 g/eq. or less, good reactivity is realized between the epoxy compound (A) and the aromatic amine compound (B1), so that unreacted amino groups hardly remain in the cured product, and moisture absorption of the cured product caused by an amino group can be suppressed. When the active hydrogen equivalent of the alicyclic amine compound (B2) is 30 g/eq. or more, moisture absorption of the cured product caused by an active hydrogen in the cured product can be suppressed. When the active hydrogen equivalent of the alicyclic amine compound (B2) is 50 g/eq. or less, advantageously, the alicyclic amine compound (B2) and the epoxy compound (A) react with each other to smoothly form a crosslinked structure.

As a result, it is presumed that adhesion between the cured product and a metal is good, and a decrease in adhesion due to moisture absorption of the cured product can be suppressed.

The aromatic amine compound (B1) is an amine compound having an aromatic ring in the molecule and having an active hydrogen equivalent of 50 g/eq. or more and 320 g/eq. or less. When the aromatic amine compound (B1) contains plural kinds of compounds, each of the plural kinds of compounds has an active hydrogen equivalent of 50 g/eq. or more and 320 g/eq. or less. The active hydrogen equivalent of the aromatic amine compound (B1) is more preferably 52 g/eq. or more, and still more preferably 53 g/eq. or more. The active hydrogen equivalent is more preferably 318 g/eq. or less, and still more preferably 316 g/eq. or less.

The aromatic amine compound (B1) has, for example, at least one selected from a group consisting of a benzene ring as an aromatic ring in the molecule. The aromatic amine compound (B1) contains, for example, a compound having two aromatic rings having an amino group bonded thereto in the molecule. The aromatic amine compound (B1) contains, for example, at least one selected from a group consisting of 4,4′-diamino-3,3′-dimethyldiphenylmethane represented by the following formula (1), 4,4′-diaminodiphenylsulfone represented by the following formula (2), trimethylene bis (4-aminobenzoate) represented by the following formula (3), and poly (1,4-butanediol) bis (4-aminobenzoic acid) represented by the following formula (4).

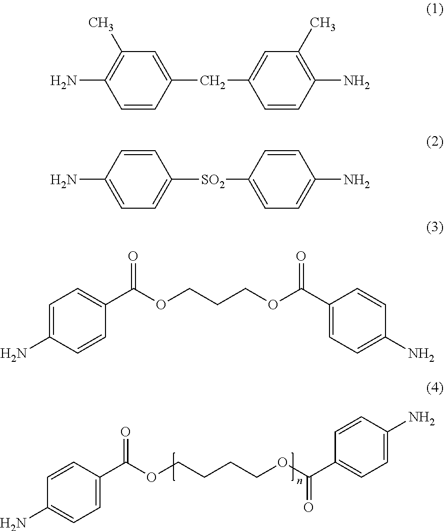

In the formula (4), “n” represents the number of repeating units, and is defined so that the active hydrogen equivalent of poly (1,4-butanediol) bis (4-aminobenzoic acid) represented by the formula (4) is 50 g/eq. or more and 320 g/eq. or less.

A proportion of the aromatic amine compound (B1) in the solid content of the composition (X) is preferably 3 mass % or more and 20 mass % or less. When the proportion is 3 mass % or more, adhesion of the cured product to a metal can be further improved, and the hygroscopicity of the cured product can be further reduced. The proportion is more preferably 3.2 mass % or more, and still more preferably 3.5 mass % or more. When the proportion is 20 mass % or less, the hygroscopicity of the cured product can be further reduced. The proportion is more preferably 19.8 mass % or less, and still more preferably 19.5 mass % or less.

The alicyclic amine compound (B2) is an amine compound having an aliphatic ring in the molecule and having an active hydrogen equivalent of 30 g/eq. or more and 50 g/eq. or less. When the alicyclic amine compound (B2) contains plural kinds of compounds, each of the plural kinds of compounds has an active hydrogen equivalent of 30 g/eq. or more and 50 g/eq. or less. The active hydrogen equivalent of the alicyclic amine compound (B2) is more preferably 31 g/eq. or more, and still more preferably 33 g/eq. or more. The active hydrogen equivalent is more preferably 49 g/eq. or less, and still more preferably 47 g/eq. or less.

The alicyclic amine compound (B2) has, for example, at least one selected from a group consisting of a cyclohexane ring and norbornene as an aliphatic ring in the molecule. The aromatic amine compound (B1) contains, for example, a compound having two aromatic rings and two amino groups in the molecule. The aromatic amine compound (B1) contains, for example, at least one of norbornanediamine represented by the following formula (5) and isophoronediamine represented by the following formula (6).

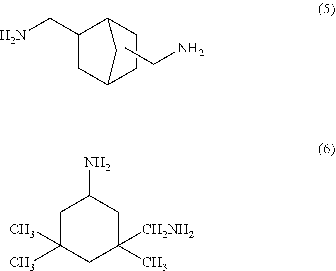

A proportion of the alicyclic amine compound (B2) in the solid content of the composition (X) is preferably 3 mass % or more and 13 mass % or less. When the proportion is 3 mass % or more, the hygroscopicity of the cured product can be further reduced. The proportion is more preferably 3.1 mass % or more, and still more preferably 3.3 mass % or more. When the proportion is 13 mass % or less, advantageously, the cured product does not become brittle. The proportion is more preferably 12.8 mass % or less, and still more preferably 12.5 mass % or less.

The curing agent (B) may further contain an amine compound that is neither the aromatic amine compound (B1) nor the alicyclic amine compound (B2) (hereinafter, also referred to as amine compound (B3)) as long as the object of the present disclosure is not excessively inhibited. When the curing agent (B) contains the amine compound (B3), a proportion of the amine compound (B3) in the total of the aromatic amine compound (B1), the alicyclic amine compound (B2), and the amine compound (B3) is preferably 5 mass % or less.

The composition (X) may include an activator (C). The activator (C) is a substance that exhibits a flux action in soldering. The flux action means a reducing action to remove an oxide film generated on a solder and a conductor, and an action to decrease the surface tension of a molten solder to increase the wettability of the solder to a metal surface. When the composition (X) contains the activator (C), the conduction reliability between the solder and the conductor can be improved.

The activator (C) preferably contains at least one of an organic acid (C1) or an amine (C2). The organic acid (C1) has a carboxyl group equivalent of 40 g/eq or more and 400 g/eq or less, and has a melting point of 220° C. or less. The amine (C2) has a nitrogen atom equivalent of 10 g/eq or more and 300 g/eq or less, and has a melting point of 220° C. or less. When the melting point of the activator (C) is 220° C. or lower, the oxide film of the solder can be removed before the solder is melted even when a solder having a melting point of around 200° C. or 200° C. or higher is used. The “carboxyl group equivalent” is a value obtained by dividing the mass (g) of one mole of a substance by the number of carboxyl groups per molecule of the substance, and the “nitrogen atom equivalent” is a value obtained by dividing the mass (g) of one mole of a substance by the number of nitrogen atoms per molecule of the substance.

The organic acid (C1) can contain, for example, at least one selected from a group consisting of a rosin component material, adipic acid, glutaric acid, succinic acid, malonic acid, citric acid, core acid, sebacic acid, and pimelic acid. The organic acid (C1) preferably contains at least one selected from a group consisting of succinic acid (carboxyl group equivalent: 59 g/eq), glutaric acid (carboxyl group equivalent: 66 g/eq), adipic acid (carboxyl group equivalent: 73 g/eq), core acid (carboxyl group equivalent: 87 g/eq), sebacic acid (carboxyl group equivalent: 101 g/eq), and Tsunodyme 395 (carboxyl group equivalent: 288 g/eq).

The amine (C2) is not particularly limited as long as it is an amine used as a flux, and can contain, for example, at least one or more selected from a group consisting of various amine salts, alkanolamines, and guanidine. The amine (C2) particularly preferably contains at least one selected from a group consisting of diethanolamine (nitrogen atom equivalent: 105 g/eq), triethanolamine (TEA) (nitrogen atom equivalent: 149 g/eq), triisopropanolamine (nitrogen atom equivalent: 191 g/eq), 1,3-diphenylguanidine (nitrogen atom equivalent: 70 g/eq), and 1,3-di-o-tolylguanidine (nitrogen atom equivalent: 80 g/eq).

The activator (C) may contain components other than the organic acid (C1) and the amine (C2). For example, the activator (C) may contain an organic acid or amine having a melting point of higher than 220° C.

A proportion of the activator (C) in the solid content of the composition (X) is preferably 1.5 mass % or more and 25 mass % or less. When the proportion is 4 mass % or more, the flux action is favorably exhibited, and the conduction reliability can be further enhanced between the conductor and the solder. When the proportion is 25 mass % or less, a decrease in the storage stability of the composition (X) is suppressed, a decrease in the glass transition temperature of the cured product is suppressed, and a decrease in joint strength between the conductor and the solder can be suppressed. Furthermore, the activator (C) is a polar compound. When a proportion of the activator (C) is 25 mass % or less, moisture absorption of the cured product by the activator (C) can be suppressed. The proportion is more preferably 2.5 mass % or more. The proportion is more preferably 23 mass % or less.

The composition (X) may contain a thixotropic agent (D). The thixotropic agent (D) is a compound that imparts thixotropy to the composition (X). Thixotropy is a property to decrease the viscosity of a substance when a shear stress is applied. Thixotropy is quantified by thixotropy ratio (thixotropy index). In other words, the thixotropic agent (D) is a compound capable of increasing the thixotropy ratio. For example, under a constant temperature, viscosity is measured under each of two conditions different from each other in the rotational speed of a rotary viscometer, and the ratio of the two viscosities obtained as a result can be defined as the thixotropy ratio.

The thixotropic agent (D) contains, for example, at least one selected from a group consisting of 1,3:2,4-bis-O-benzylidene-D-glucitol (dibenzylidene sorbitol) (for example, manufactured by New Japan Chemical Co., Ltd., product name: GEL ALL D), 1,3:2,4-bis-O-(4-methylbenzylidene)-D-sorbitol (for example, manufactured by New Japan Chemical Co., Ltd., product name: GEL ALL MD), and N,N′-methylenebis (stearoamide) (for example, manufactured by Mitsubishi Chemical Corporation, product name: BISAMIDE LA).

A proportion of the thixotropic agent (D) in the solid content of the composition (X) is preferably 1 mass % or more and 7 mass % or less. In this case, the composition (X) can have an appropriate thixotropy ratio.

The composition (X) may contain a solvent (E) as necessary. The solvent (E) is preferably an ether-based solvent. The solvent (E) preferably contains glycol ethers. For example, the solvent (E) contains at least one selected from a group consisting of diethylene glycol diethyl ether, ethylene glycol mono-2-ethyl hexyl ether, hexyl diglycol, and the like.

The amount of the solvent (E) may be appropriately set so that the composition (X) has an appropriate viscosity. A proportion of the solvent in the composition (X) is, for example, 2 mass % or more and 25 mass % or less.

The composition (X) may contain an additive (F), which is a component other than the epoxy compound (A), the curing agent (B), the alicyclic amine compound (B2), the activator (C), the thixotropic agent (D), and the solvent (E). The additive (F) contains, for example, at least one selected from a group consisting of a phenol compound, an imidazole compound, a benzoxazine compound, a component modifier, a filler, and the like. A proportion of the additive (F) in the solid content of the composition (X) is preferably 5 mass % or less.

The viscosity of the composition (X) is preferably 10 Pa·s or more and 250 Pa·s or less. In this case, the composition (X) is easily applied to the joint between the conductor and the solder bump. That is, the coating property of the composition (X) can be improved. The viscosity is more preferably 25 Pa·s or more, and still more preferably 30 Pa·s or more. The viscosity is more preferably 120 Pa·s or less, and still more preferably 110 Pa·s or less. The viscosity of the composition (X) is a value measured under conditions of 25° C. and a rotation speed of 2.5 rpm using an E-type viscometer.

The thixotropy ratio of the composition (X) is preferably 1.5 or more and 8 or less. In this case, the coating property of the composition (X) can be enhanced. The thixotropy ratio is the ratio value η_{0.25}/η_{2.5} between the viscosity η_{0.25} measured by an E-type viscometer under the conditions of 25° C. and a rotation speed of 0.25 rpm and the viscosity η_{2.5} measured by an E-type viscometer under the conditions of 25° C. and a rotation speed of 2.5 rpm. The thixotropy ratio is more preferably 1.5 or more, and still more preferably 2.0 or more. The thixotropy ratio is more preferably 5.0 or less, and still more preferably 4.5 or less.

The glass transition temperature of the cured product of the composition (X) is preferably 100° C. or higher. In this case, the heat resistance of the cured product is more easily improved, and thus the heat cycle resistance of the cured product and the mounted structure can be further improved. The glass transition temperature is more preferably 125° C. or higher.

### 2. MOUNTED STRUCTURE

Reinforcing part 4 in mounted structure 1 can be produced from the composition (X).

Mounted structure 1 of the exemplary embodiment includes base material 2, mounted component 3, solder bump 32, and reinforcing part 4. Base material 2 includes first conductor 21. Mounted component 3 includes second conductor 31. Solder bump 32 is interposed between first conductor 21 and second conductor 31, and electrically connects first conductor 21 to second conductor 31. Reinforcing part 4 includes a cured product of the composition (X), and covers at least one of joint 20 between first conductor 21 and solder bump 32 or joint 20 between second conductor 31 and solder bump 32.

FIG. 1 illustrates mounted structure 1 according to the exemplary embodiment.

Base material 2 is, for example, a mother substrate, a package substrate, or an interposer substrate. Base material 2 includes an insulating substrate such as a glass epoxy substrate, a polyimide substrate, a polyester substrate, or a ceramic substrate, and first conductor 21 prepared on the insulating substrate. First conductor 21 is, for example, a conductor wiring made of metal.

Mounted component 3 is, for example, a semiconductor chip. More specifically, mounted component 3 is a flip-chip type chip such as a ball grid array (BGA), a land grid array (LGA), or a chip size package (CSP). Mounted component 3 may be a wafer level package (WLP). Mounted component 3 may be a package-on-package (PoP) type chip.

Mounted component 3 includes second conductor 31. Second conductor 31 is, for example, a pad (terminal electrode) on a semiconductor chip. For example, when mounted component 3 is a BGA, mounted component 3 is a package formed by sealing a die mounted on a substrate with a sealing resin, and second conductor 31 is a terminal electrode electrically connected to the die. For example, when mounted component 3 is a WLP, mounted component 3 includes a silicon substrate provided with a rewiring layer, and second conductor 31 is a pillar electrically connected to the rewiring layer. Note that the structure of mounted component 3 is not limited to the above, and is an appropriate structure according to the type of mounted component 3.

Solder bump 32 is interposed between first conductor 21 of base material 2 and second conductor 31 of mounted component 3. Solder bump 32 electrically connects first conductor 21 to second conductor 31. Solder bump 32 may be, for example, Sn—Ag—Cu (SAC) solder or Sn—Bi (tin copper) solder.

When solder bump 32 is the SAC solder, the melting point of solder bump 32 is, for example, 217° C. or more and 230° C. or less.

The Sn—Bi solder may contain at least one material selected from a group consisting of Ag, Ni, Fe, Ge, Cu, In, and the like in addition to Sn and Bi. In order to improve the mechanical performance of the Sn—Bi solder, the Sn—Bi solder preferably contains at least one material selected from a group consisting of Ag, Ni, Fe, Ge, and the like.

As described above, reinforcing part 4 includes the cured product of the composition (X). In mounted structure 1 illustrated in FIG. 1, reinforcing part 4 covers joint 20 between solder bump 32 and first conductor 21. Thus, reinforcing part 4 can reinforce joint 20 between solder bump 32 and first conductor 21. Hence, conduction failure between first conductor 21 and solder bump 32 is suppressed, and mounted structure 1 can have good connection reliability. In the exemplary embodiment, reinforcing part 4 can have high heat resistance and high heat cycle resistance. As a result, mounted structure 1 can have high heat resistance and high heat cycle resistance.

In the exemplary embodiment, joint 20 between second conductor 31 and solder bump 32 is covered with reinforcing part 4.

The method for producing mounted structure 1 will be described.

The composition (X) is interposed at least one of between first conductor 21 and solder bump 32 or between second conductor 31 and solder bump 32. In this state, mounted component 3 is flip-mounted on base material 2 by soldering. Thus, mounted structure 1 including reinforcing part 4 can be produced.

Specifically, first, the composition (X), base material 2 including first conductor 21, mounted component 3 including second conductor 31, and solder bump 32 are prepared.

The composition (X) is disposed on first conductor 21 by, for example, applying the composition (X) onto first conductor 21 of base material 2. The method for applying the composition (X) is a printing method, a transfer method, or the like, but is not limited thereto. Examples of the printing method include an inkjet method.

Solder bump 32 is provided on mounted component 3 so that solder bump 32 is in contact with second conductor 31. Solder bump 32 is, for example, a solder ball.

Base material 2 and mounted component 3 are disposed so that first conductor 21 of base material 2 and second conductor 31 of mounted component 3 face each other and solder bump 32 is in contact with the composition (X). Thus, the composition (X) is interposed between solder bump 32 and first conductor 21.

In this state, solder bump 32 and the composition (X) are heated in a heating furnace such as a reflow furnace.

When solder bump 32 and the composition (X) are heated, for example, first, solder bump 32 and the composition (X) are heated to around the melting point of the composition (X). For example, the composition (X) and solder bump 32 are heated to a temperature of 140° C. or more and 160° C. or less. As a result, the viscosity of the composition (X) decreases, so that the composition (X) flows, and accordingly, solder bump 32 comes into contact with first conductor 21.

Subsequently, solder bump 32 and the composition (X) are heated to a temperature higher than the melting point of the solder. For example, the composition (X) and solder bump 32 are heated to a temperature of 232° C. or more and 255° C. or less. As a result, solder bump 32 melts, and wets and spreads between first conductor 21 and second conductor 31. As a result, first conductor 21 and second conductor 31 are electrically connected via solder bump 32.

Subsequently, as the composition (X) is further heated, curing of the composition (X) proceeds, and reinforcing part 4 including the cured product of the composition (X) is produced.

Thus, mounted structure 1 including reinforcing part 4 is produced.

### 3. MODIFICATIONS

The first modification and the second modification of mounted structure 1 will be described with reference to FIG. 2 and FIG. 3, respectively. Note that, in these modifications, the components similar to those of mounted structure 1 of the exemplary embodiment are denoted by the same reference numerals as those of the exemplary embodiment in the drawings, and the detailed description thereof will be appropriately omitted.

In mounted structure 1 of the first modification shown in FIG. 2, joint 20 between first conductor 21 of mounted component 3 and solder bump 32 is not covered with reinforcing part 4, and joint 20 between second conductor 31 of mounted component 3 and solder bump 32 is covered with reinforcing part 4. Even in this case, the heat cycle resistance of mounted structure 1 can be improved.

When mounted structure 1 of the first modification is produced, for example, in a state where solder bump 32 is provided on base material 2 so that solder bump 32 is in contact with first conductor 21, base material 2 and mounted component 3 are disposed so that first conductor 21 of base material 2 and second conductor 31 of mounted component 3 face each other and solder bump 32 is in contact with the composition (X). Thus, the composition (X) is interposed between solder bump 32 and second conductor 31.

In this state, solder bump 32 and the composition (X) are heated in a heating furnace such as a reflow furnace. As a result, first conductor 21 and second conductor 31 are electrically connected via solder bump 32, and joint 20 between second conductor 31 of mounted component 3 and solder bump 32 is covered with reinforcing part 4 including the cured product of the composition (X). Thus, mounted structure 1 is produced.

In mounted structure 1 of the second modification shown in FIG. 3, joint 20 between first conductor 21 of mounted component 3 and solder bump 32 and joint 20 between second conductor 31 of mounted component 3 and solder bump 32 are each covered with reinforcing part 4. That is, mounted structure 1 includes reinforcing part 4 that covers joint 20 between first conductor 21 of mounted component 3 and solder bump 32, and reinforcing part 4 that covers joint 20 between second conductor 31 of mounted component 3 and solder bump 32. Even in this case, the heat cycle resistance of mounted structure 1 can be improved.

When mounted structure 1 of the second modification is produced, for example, the composition (X) is disposed on each of first conductor 21 and second conductor 31. In this state, base material 2 and mounted component 3 are disposed so that first conductor 21 of base material 2 and second conductor 31 of mounted component 3 face each other, and solder bump 32 is interposed between first conductor 21 and second conductor 31 so that solder bump 32 is in contact with both the composition (X) on first conductor 21 and the composition (X) on second conductor 31.

In this state, solder bump 32 and the composition (X) are heated in a heating furnace such as a reflow furnace. As a result, first conductor 21 and second conductor 31 are electrically connected via solder bump 32. In addition, each of joint 20 between first conductor 21 of base material 2 and solder bump 32 and joint 20 between second conductor 31 of mounted component 3 and solder bump 32 is covered with reinforcing part 4 including the cured product of the composition (X). Thus, mounted structure 1 is produced.

Optionally, first, first conductor 21 and solder bump 32 are joined, and joint 20 between first conductor 21 and solder bump 32 are covered with reinforcing part 4, and then, second conductor 31 and solder bump 32 are joined, and joint 20 between second conductor 31 and solder bump 32 are covered with reinforcing part 4. Optionally, first, second conductor 31 and solder bump 32 are joined, and joint 20 between second conductor 31 and solder bump 32 are covered with reinforcing part 4, and then, first conductor 21 and solder bump 32 are joined, and joint 20 between first conductor 21 and solder bump 32 are covered with reinforcing part 4.

In addition, reinforcing part 4 covering joint 20 between second conductor 31 and solder bump 32 and reinforcing part 4 covering joint 20 between first conductor 21 and solder bump 32 may be separated or may be integrated without being separated.

### 4. EMBODIMENTS

The reinforcing resin composition according to the first embodiment includes: an epoxy compound (A); an aromatic amine compound (B1) having an active hydrogen equivalent of 50 g/eq. or more and 320 g/eq. or less; and an alicyclic amine compound (B2) having an active hydrogen equivalent of 30 g/eq. or more and 50 g/eq. or less.

According to the embodiment, the cured product of the reinforcing resin composition has adhesiveness to a metal and is less likely to absorb moisture, so that deterioration of adhesiveness over time due to moisture absorption can be suppressed.

According to the second embodiment, in the first embodiment, a proportion of the epoxy compound (A) in a solid content of the reinforcing resin composition is 48 mass % or more and 85 mass % or less, a proportion of the aromatic amine compound (B1) in the solid content of the reinforcing resin composition is 3 mass % or more and 20 mass % or less, and a proportion of the alicyclic amine compound (B2) in the solid content of the reinforcing resin composition is 3 mass % or more and 13 mass % or less.

According to the third embodiment, in the first or second embodiment, the epoxy compound (A) includes an epoxy compound (A1) including at least one selected from a group consisting of a naphthalene epoxy resin, a biphenyl aralkyl epoxy resin, a trisphenol methane epoxy resin, a biphenyl epoxy resin, and a dicyclopentadiene epoxy resin.

According to the fourth embodiment, in the third embodiment, a proportion of the epoxy compound (A1) in a solid content of the reinforcing resin composition is 16 mass % or more and 35 mass % or less.

According to the fifth embodiment, in any one of the first to fourth embodiments, the reinforcing resin composition further includes an activator (C).

According to the sixth embodiment, in the fifth embodiment, a proportion of the activator (C) in a solid content of the reinforcing resin composition is 1.5 mass % or more and 25 mass % or less.

According to the seventh embodiment, in any one of the first to sixth embodiments, the reinforcing resin composition further includes a thixotropic agent (D).

According to the eighth embodiment, in the seventh embodiment, a proportion of the thixotropic agent (D) in a solid content of the reinforcing resin composition is 1 mass % or more and 7 mass % or less.

Mounted structure (1) according to the ninth embodiment includes: base material (2) including first conductor (21); mounted component (3) including second conductor (31); solder bump (32) electrically connecting first conductor (21) to second conductor (31), solder bump (32) being disposed between first conductor (21) and second conductor (31); and reinforcing part (4) including a cured product of the reinforcing resin composition according to any one of the first to eighth embodiments. Reinforcing part (4) covers at least one of joint (20) between first conductor (21) and solder bump (32) or joint (20) between second conductor (31) and solder bump (32).

According to the embodiment, reinforcing part (4) has adhesiveness to solder bump (32) and the like, and is less likely to absorb moisture, so that deterioration of adhesiveness over time due to moisture absorption can be suppressed.

### EXAMPLES

Hereinafter, specific examples of the present disclosure will be presented. Note that the present disclosure is not limited only to the following examples.

### 1. Preparation of Resin Composition

The components shown in Table 1 and Table 2 are mixed in the proportion shown in Table 1 and Table 2 to obtain resin compositions. The details of the components shown in Table 1 and Table 2 are as follows.
Epoxy compound #1: A trisphenol methane epoxy resin represented by the formula (18). Epoxy group equivalent 162. Manufactured by DIC Corporation. Product name HP-7250.
Epoxy compound #2: A mixture of a naphthalene epoxy resin represented by the formula (15) and a naphthalene epoxy resin represented by the formula (16). Epoxy group equivalent 215. Manufactured by DIC Corporation. Product name HP-6000L.
Epoxy compound #3: A naphthalene epoxy resin represented by the formula (11). Epoxy group equivalent 136 to 148. Manufactured by DIC Corporation. Product name HP-4032D.
Epoxy compound #4: A biphenyl aralkyl epoxy resin represented by the formula (20). Epoxy group equivalent 280 to 300. Manufactured by Nippon Kayaku Co., Ltd. Product name NC-3000-H.
Epoxy compound #5: A biphenyl epoxy resin represented by the formula (21). Epoxy group equivalent 187 to 197. Manufactured by Mitsubishi Chemical Corporation. Product name YX4000H.
Epoxy compound #6: A dicyclopentadiene epoxy resin represented by the formula (22). Epoxy group equivalent 280 to 292. Manufactured by DIC Corporation. Product name HP-7200HHH.
Epoxy compound #7: A bisphenol epoxy resin that is liquid at 25° C. Manufactured by NIPPON STEEL Chemical & Material Co., Ltd. Product name YD8125.
Epoxy compound #8: A bisphenol epoxy resin that is liquid at 25° C. Manufactured by NIPPON STEEL Chemical & Material Co., Ltd. Product name YDF8170.
Aromatic amine compound #1: 4,4′-diamino-3,3′-dimethyldiphenylmethane represented by the formula (1). Active hydrogen equivalent 56.6 g/eq. Manufactured by Tokyo Chemical Industry Co., Ltd.
Aromatic amine compound #2: 4,4-diaminodiphenyl sulfone represented by the formula (2). Active hydrogen equivalent 62.1 g/eq. Manufactured by Tokyo Chemical Industry Co., Ltd.
Aromatic amine compound #3: Trimethylenebis (4-aminobenzoate) represented by the formula (3). Active hydrogen equivalent 78.6 g/eq. Manufactured by KUMIAI CHEMICAL INDUSTRY CO., LTD.
Aromatic amine compound #4: Poly (1,4-butanediol) bis (4-aminobenzoic acid) represented by the formula (4) in which “n” is 2.5 on average in the formula (4). Active hydrogen equivalent 127.0 g/eq. Manufactured by KUMIAI CHEMICAL INDUSTRY CO., LTD.
Aromatic amine compound #5: Poly (1,4-butanediol) bis (4-aminobenzoic acid) represented by the formula (4) in which “n” is 8.8 on average in the formula (4). Active hydrogen equivalent 232.7 g/eq. Manufactured by KUMIAI CHEMICAL INDUSTRY CO., LTD.
Aromatic amine compound #6: Poly (1,4-butanediol) bis (4-aminobenzoic acid) represented by the formula (4) in which “n” is 14.2 on average in the formula (4). Active hydrogen equivalent 311.03 g/eq. Manufactured by KUMIAI CHEMICAL INDUSTRY CO., LTD.
Aromatic amine compound #7: Poly (1,4-butanediol) bis (4-aminobenzoic acid) represented by the formula (4) in which “n” is 15.6 on average in the formula (4). Active hydrogen equivalent 334.8 g/eq. Manufactured by KUMIAI CHEMICAL INDUSTRY CO., LTD.
Aromatic amine compound #8: Diethyltoluenediamine represented by the following formula. Active hydrogen equivalent 44.5 g/eq. Manufactured by Mitsui Fine Chemicals, Inc.

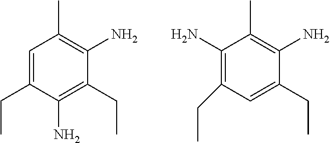

Alicyclic amine compound #1: Norbornanediamine represented by the formula (5). Active hydrogen equivalent 38.5 g/eq. Manufactured by Mitsui Fine Chemicals, Inc.
Alicyclic amine compound #2: Isophoronediamine represented by the formula (6). Active hydrogen equivalent 42.6 g/eq. Manufactured by Tokyo Chemical Industry Co., Ltd.
Aliphatic amine compound: Poly (propylene glycol) diamine represented by the following formula. Active hydrogen equivalent 100.0 g/eq. Manufactured by Mitsui Fine Chemicals, Inc.

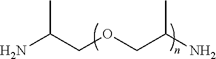

Activator #1: Adipic acid. Manufactured by Tokyo Chemical Industry Co., Ltd.
Activator #2: Glutaric acid. Manufactured by Tokyo Chemical Industry Co., Ltd.
Activator #3: Triethanolamine. Manufactured by Tokyo Chemical Industry Co., Ltd.
Activator #4: 1,3-diphenylguanidine. Manufactured by Tokyo Chemical Industry Co., Ltd.
Activator #5: Manufactured by TSUNO FOOD INDUSTRIAL CO., LTD. Product name: Tsunodyme 395. Containing 94% dimer acid.
Thixotropic agent #1:1,3:2,4-bis-O-benzylidene-D-glucitol (dibenzylidene sorbitol). Manufactured by New Japan Chemical Co., Ltd. Product name: GEL ALL D.
Thixotropic agent #2: 1,3:2,4-bis-O-(4-methylbenzylidene)-D-sorbitol. Manufactured by New Japan Chemical Co., Ltd. Product name: GEL ALL MD.
Thixotropic agent #3: N,N′-methylenebis (stearoamide). Manufactured by Mitsubishi Chemical Corporation. Product name BISAMIDE LA.
Solvent #1: Diethylene glycol diethyl ether. Manufactured by NIPPON NYUKAZAI CO., LTD.
Solvent #2: Diethylene glycol monohexyl ether. Manufactured by NIPPON NYUKAZAI CO., LTD.

### 2. Evaluation

The resin composition was subjected to the following evaluation tests. The results are shown in Table 1 and Table 2.

### (1) Viscosity

Using an E-type viscometer (manufactured by Toki Sangyo Co., Ltd., product number: RE-215U), the viscosity of the resin composition was measured at 25° C. and a rotation speed of 2.5 rpm.

### (2) Thixotropy Ratio

Using an E-type viscometer (manufactured by Toki Sangyo Co., Ltd., product number: RE-215U), the viscosity η_{0.25} of the resin composition at 25° C. and a rotation speed of 0.25 rpm and the viscosity η_{2.5} thereof at 25° C. and a rotation speed of 2.5 rpm were measured. Based on the measurement results, the ratio value η_{0.25}/η_{2.5} was calculated as the thixotropy ratio.

### (3) Coating Property

As for a substrate having a plurality of Ni—Pd—Au alloy pads arranged at intervals of 0.5 mm and having a diameter of 300 μm, on each pad, the resin composition was applied using a printing machine (SP-80V, manufactured by Panasonic Smart Factory Solutions Co., Ltd.) to form a coating film of the resin composition covering each pad. The state of the coating film was observed with a microscope and evaluated according to the following criteria.

A: There is no problem in the shape of the coating film.

B: There are bridges between coating films and coating film defects, but there is no problem in practical use.

C: There are many bridges between coating films and coating film defects.

### (4) Wet Spreadability

In accordance with JIS Z 3198-3, the resin composition was disposed on a copper plate, a solder sample was placed thereon, and in this state, the resin composition and the solder sample were heated. Based on the results, the spreading rate of the solder sample was calculated. As the solder sample, a solder ball having a diameter of 300 m and made of SAC305 (composition: Sn: 96.5%, Ag: 3.0%, and Cu: 0.5%, melting point 219° C.), which is a lead-free solder, was used. As the heating conditions, first, the temperatures of the resin composition and the solder sample were raised to a range of 220 to 225° C., and the temperature was maintained in this range for 60 seconds. Subsequently, the temperature was lowered to room temperature.

When the spreading rate is 50% or more, it can be evaluated that the wet spreadability is excellent, and when the spreading rate is 60% or more, it can be evaluated that the wet spreadability is particularly excellent.

### (5) Hygroscopicity

The composition was molded and heated at 150° C. for 1 hour and then heated at 200° C. for 3 hours to be cured, thereby preparing a sample having a dimension of 100 mm in length×5 mm in width×2 mm in thickness. The weight (initial weight) of this sample was measured. Subsequently, the sample was exposed to an atmosphere of 85° C. and 85% RH for 24 hours, and immediately thereafter, the weight (hygroscopic weight) of the sample was measured.

From these results, the moisture absorption rate (%) of the sample was calculated by the formula [{(weight after moisture absorption)−(initial weight)}/(initial weight)]×100.

When the moisture absorption rate is less than 1.0%, it can be evaluated that the hygroscopicity of the sample is considerably low, and when the moisture absorption rate is less than 0.7%, it can be evaluated that the hygroscopicity of the sample is extremely low.

(6) Initial Adhesion Strength and Adhesion Reduction Rate after Moisture Absorption

The composition was heated at 150° C. for 1 hour and then heated at 200° C. for 3 hours to prepare 10 samples each having a diameter of 2 mm and a height of 2 mm on a copper plate.

For five samples, the shear strength to the copper plate was measured in accordance with JEITA ED-4703 using a bond tester (manufactured by Nordson Advanced Technology). The average value of the five measured values thus obtained was defined as the initial adhesion strength.

Five samples that were not subjected to the measurement of the initial adhesion strength were exposed to an atmosphere of 85° C. and 85% RH for 24 hours, and then passed three times through a reflow furnace at a peak top temperature of 250° C. Subsequently, for these five samples, the shear strength to the copper plate was measured with the bond tester. The average value of the five measured values thus obtained was defined as the adhesion strength after moisture absorption.

From these results, the reduction rate (%) of the adhesion strength of the sample after moisture absorption was calculated by the formula [{(initial adhesion strength)−(adhesion strength after moisture absorption)}/(initial adhesion strength)]×100.

When the initial adhesion strength is 140 gf (about 1.37 N) or more, it can be evaluated that the initial adhesion is excellent, and when the initial adhesion strength is 150 gf (about 1.47 N) or more, it can be evaluated that the initial adhesion is very excellent.

When the adhesion strength reduction rate after moisture absorption is less than 20%, it can be evaluated that the moisture absorption resistance is excellent, and when the adhesion strength reduction rate after moisture absorption is less than 10%, it can be evaluated that the moisture absorption resistance is very excellent.

TABLE 1

| | | Examples | | | | | | | | | |
|---|---|---|---|---|---|---|---|---|---|---|---|
| | | 1 | 2 | 3 | 4 | 5 | 6 | 7 | 8 | 9 | 10 |
| Composition | Epoxy compound #1 | 22.2 | | | | | | 22.2 | 11.1 | | 21.3 |
| (part by | Epoxy compound #2 | | 25 | | | | | | 11.1 | | |
| mass) | Epoxy compound #3 | | | 17.2 | | | | | | | |
| | Epoxy compound #4 | | | | 22.2 | | | | | 15 | |
| | Epoxy compound #5 | | | | | 22.2 | | | | 7.2 | |
| | Epoxy compound #6 | | | | | | 22.2 | | | | |
| | Epoxy compound #7 | 28.5 | 29.5 | 21.3 | 28.5 | 28.5 | 28.5 | 28.5 | 28.5 | 28.5 | 24.5 |
| | Epoxy compound #8 | 12.6 | 18.8 | 7.6 | 12.6 | 12.6 | 12.6 | 12.6 | 12.6 | 12.6 | 15.9 |
| | Aromatic amine compound #1 | 6.7 | 4 | | | | | 4 | 5.7 | | 4.5 |
| | Aromatic amine compound #2 | | | 5 | | | | 4 | | 2 | |
| | Aromatic amine compound #3 | | | | 5.7 | | | | | 3.7 | |
| | Aromatic amine compound #4 | | | | | 4 | | | | | |
| | Aromatic amine compound #5 | | | 5 | | | 2 | | | | |
| | Aromatic amine compound #6 | | | 8.9 | | | 2.7 | | | | |
| | Aromatic amine compound #7 | | | | | | | | | | |
| | Aromatic amine compound #8 | | | | | | | | | 2 | |
| | Alicyclic amine compound #1 | 5 | 5.2 | | | 7.7 | 7 | 3.7 | | 2 | 7.2 |
| | Alicyclic amine compound #2 | | | 5 | 6 | | | | 6 | 2 | |
| | Aliphatic amine compound | | | | | | | | | | |
| | Activator #1 | | | | | | | | | | |
| | Activator #2 | 0.8 | 0.8 | 0.8 | 0.8 | 0.8 | 0.8 | 0.8 | 0.8 | 0.8 | 1.2 |
| | Activator #3 | | | | | | | | | | |
| | Activator #4 | | | | | | | | | | |
| | Activator #5 | 6.8 | 6.8 | 6.8 | 6.8 | 6.8 | 6.8 | 6.8 | 6.8 | 6.8 | 18 |
| | Thixotropic agent #1 | 2.4 | 2.4 | 4.4 | 2.4 | 2.4 | 2.4 | 2.4 | 2.4 | 2.4 | 2.4 |
| | Thixotropic agent #2 | | | | | | | | | | |
| | Thixotropic agent #3 | | | | | | | | | | |
| | Solvent #1 | 15 | 7.5 | 18 | 15 | 15 | 15 | 15 | 15 | 15 | 5 |
| | Solvent #2 | | | | | | | | | | |
| Evaluation | Viscosity (Pa · s) | 71 | 92 | 69 | 73 | 81 | 75 | 83 | 77 | 80 | 76 |
| | Thixotropy ratio | 2.3 | 3.0 | 2.6 | 3.0 | 2.9 | 2.8 | 2.5 | 2.7 | 2.9 | 3.2 |
| | Coating property | A | B | A | A | A | A | A | A | A | A |
| | Wet spreadability (%) | 73 | 68 | 71 | 67 | 65 | 70 | 63 | 64 | 69 | 71 |
| | Moisture absorption rate (%) | 0.4 | 0.5 | 0.9 | 0.6 | 0.5 | 0.4 | 0.6 | 0.5 | 0.6 | 0.6 |
| | Initial adhesion strength (N) | 1.62 | 1.69 | 1.68 | 1.65 | 1.60 | 1.63 | 1.59 | 1.67 | 1.62 | 1.66 |
| | Adhesion strength reduction rate | 6.4 | 5.7 | 12.3 | 7.1 | 8.2 | 7.5 | 8.1 | 6.8 | 7.2 | 8.5 |
| | after moisture absorption (%) | | | | | | | | | | |

TABLE 2

| | | Examples | | | | | Comparative Examples | | | |
|---|---|---|---|---|---|---|---|---|---|---|
| | | 11 | 12 | 13 | 14 | 15 | 1 | 2 | 3 | 4 |
| Composition | Epoxy compound #1 | 22.2 | 22.2 | 22.2 | | 22.2 | 22.2 | 22.2 | 22.2 | 22.2 |
| (part by mass) | Epoxy compound #2 | | | | | | | | | |
| | Epoxy compound #3 | | | | | | | | | |
| | Epoxy compound #4 | | | | 27.5 | | | | | |
| | Epoxy compound #5 | | | | | | | | | |
| | Epoxy compound #6 | | | | | | | | | |
| | Epoxy compound #7 | 28.5 | 28.5 | 28.5 | 30.5 | 28.5 | 28.5 | 28.5 | 28.5 | 28.5 |
| | Epoxy compound #8 | 12.6 | 12.6 | 12.6 | 19.8 | 12.6 | 12.6 | 12.6 | 12.6 | 12.6 |
| | Aromatic amine compound #1 | | | | 4 | 5 | | | | |
| | Aromatic amine compound #2 | 5 | 5 | 5 | | | | | | |
| | Aromatic amine compound #3 | | | | | | | | | |
| | Aromatic amine compound #4 | | | | | | | | | |
| | Aromatic amine compound #5 | | | | | | | | | |
| | Aromatic amine compound #6 | | | | | | | | | |
| | Aromatic amine compound #7 | | | | | | | | | 6.7 |
| | Aromatic amine compound #8 | | | | | | 11.7 | | | |
| | Alicyclic amine compound #1 | | | | 5.2 | | | | 11.7 | 10 |
| | Alicyclic amine compound #2 | 6.7 | 6.7 | 6.7 | | 8.9 | | | | |
| | Aliphatic amine compound | | | | | | | 21.7 | | |
| | Activator #1 | | 0.8 | | | | | | | |
| | Activator #2 | 0.4 | | 0.8 | 0.8 | 0.4 | 0.8 | 0.8 | 0.8 | 0.8 |
| | Activator #3 | | 1.2 | | | | | | | |
| | Activator #4 | | 1.2 | | | | | | | |
| | Activator #5 | 4.8 | 4.4 | 6.8 | 5.8 | 2.6 | 6.8 | 6.8 | 6.8 | 6.8 |
| | Thixotropic agent #1 | 2.4 | 2.4 | | 2.4 | 2.4 | 2.4 | 2.4 | 2.4 | 2.4 |
| | Thixotropic agent #2 | | | 1 | | | | | | |
| | Thixotropic agent #3 | | | 1.4 | | | | | | |
| | Solvent #1 | 17.4 | 15 | 7 | 4 | 17.4 | 15 | 5 | 15 | 10 |
| | Solvent #2 | | | 8 | | | | | | |
| Evaluation | Viscosity (Pa · s) | 82 | 72 | 76 | 99 | 51 | 87 | 88 | 87 | 79 |
| | Thixotropy ratio | 2.8 | 2.5 | 2.8 | 2.1 | 3.0 | 2.9 | 2.6 | 2.9 | 2.8 |
| | Coating property | A | A | A | C | A | A | A | A | A |
| | Wet spreadability (%) | 53 | 62 | 69 | 43 | 47 | 66 | 67 | 63 | 63 |
| | Moisture absorption rate (%) | 0.4 | 0.5 | 0.5 | 0.5 | 0.5 | 1.1 | 1.4 | 0.3 | 1.2 |
| | Initial adhesion strength (N) | 1.70 | 1.65 | 1.67 | 1.57 | 1.51 | 1.59 | 1.20 | 1.31 | 1.40 |
| | Adhesion strength reduction rate | 7.6 | 8.4 | 7.9 | 7.7 | 6.7 | 22.0 | 25.0 | 5.0 | 26.0 |
| | after moisture absorption (%) | | | | | | | | | |

What is claimed is:

1. A reinforcing resin composition comprising:
an epoxy compound;
an aromatic amine compound having an active hydrogen equivalent of 50 g/eq. or more and 320 g/eq. or less; and
an alicyclic amine compound having an active hydrogen equivalent of 30 g/eq. or more and 50 g/eq. or less.

2. The reinforcing resin composition according to claim 1, wherein:
a proportion of the epoxy compound in a solid content of the reinforcing resin composition is 48 mass % or more and 85 mass % or less,
a proportion of the aromatic amine compound in the solid content of the reinforcing resin composition is 3 mass % or more and 20 mass % or less, and
a proportion of the alicyclic amine compound in the solid content of the reinforcing resin composition is 3 mass % or more and 13 mass % or less.

3. The reinforcing resin composition according to claim 1, wherein the epoxy compound includes a first epoxy compound including at least one selected from a group consisting of a naphthalene epoxy resin, a biphenyl aralkyl epoxy resin, a trisphenol methane epoxy resin, a biphenyl epoxy resin, and a dicyclopentadiene epoxy resin.

4. The reinforcing resin composition according to claim 3, wherein a proportion of the first epoxy compound in a solid content of the reinforcing resin composition is 16 mass % or more and 35 mass % or less.

5. The reinforcing resin composition according to claim 1, further comprising an activator (C).

6. The reinforcing resin composition according to claim 5, wherein a proportion of the activator in a solid content of the reinforcing resin composition is 1.5 mass % or more and 25 mass % or less.

7. The reinforcing resin composition according to claim 1, further comprising a thixotropic agent.

8. The reinforcing resin composition according to claim 7, wherein a proportion of the thixotropic agent in a solid content of the reinforcing resin composition is 1 mass % or more and 7 mass % or less.

9. A mounted structure comprising:
a base material including a first conductor;
a mounted component including a second conductor;
a solder bump connecting the first conductor to the second conductor, the solder bump being disposed between the first conductor and the second conductor; and
a reinforcing part including a cured product of the reinforcing resin composition according to claim 1,
wherein the reinforcing part covers at least one of a joint between the first conductor and the solder bump or a joint between the second conductor and the solder bump.
